(19) United States
(12) Patent Application Publication
(10) Pub. No.: US 2012/0005140 A1
(43) Pub. Date: Jan. 5, 2012

(54) Expression Conflict Resolution in Communication Network Tailoring

(76) Inventors: Frederik Hugo Zwaal, PW Breda (NL); Mieke Verheijen, Berchem (BE)

(21) Appl. No.: 13/142,687

(22) PCT Filed: Dec. 30, 2008
(86) PCT No.: PCT/NL08/50859

§ 371 Date: Sep. 22, 2011

(51) Int. Cl. G06F 15/18

(52) U.S. Cl. 706/14

(57) ABSTRACT

Rule creation engine for application in a service (5) provided in a telecommunication network (1). The rule creation engine (8) is in communication with a user terminal (10) and a database (6). The rule creation engine (8) is arranged to create an expression set, which comprises a relationship between stimulioriginating from and responses intended for the behavior of the service (5) in the telecommunication network (1), to detect one or more inconsistencies in the expression set. Furthermore, the rule creation engine is arranged to recursively determine a set of alternatives which needs the least user interaction to resolve the inconsistencies, translate the set of alternatives in a mathematical function, send to the user terminal (10) possible alternatives to resolve the mathematical function, receive from the user terminal (10) one of the possible alternatives, and update the expression set in the database (6) using the received alternative.

### TECHNICAL FIELD

The present application relates to a rule creation engine for application in a service provided in a telecommunication network, the rule creation engine in operation being in communication with a user terminal (e.g. a PC) and a database. In a further aspect, the present application relates to a method for creating rules for application in a service provided in a telecommunication network.

### BACKGROUND

Telecommunication systems become more and more complex and offer users a wide variety of services. Instead of fixed services user can nowadays also tailor how the telecommunication network will react on stimuli. Tailoring comprises creating rules and policies that provide services with the knowledge how to act or respond given a particular set of stimuli. In this the user can by creating rules and policies tailor the telecom network behaviour to his personal needs.

Due to the very large variety of possible stimuli rule creation is mostly based on a limited set of questions. With answering those rules and policies are created. Basically rules and policies can be seen as expressions defining the network behaviour. In practice however it will provide colliding or open situations (inconsistencies) inside the created rule set or with other rule sets created by the user.

These inconsistencies could be resolved by asking the user for each permutation of possible stimuli what action is to be taken. This would however seen the extreme large amount of permutations, an impossible task to do for the user.

In the prior art some solution are sought of to automate the optimization of rule and policy sets. In all cases the user must provide some input for resolving. Problem of the known solutions is that still the amount of questions asked to users for resolving is still quite large and questions require a user to have insight and knowledge of the network when answering the questions.

### SUMMARY

The present invention seeks to provide an improved solution for the problems as described above.

According to the present invention, a rule creation engine is provided which is arranged
to create an expression set, the expression set comprising a relationship between stimuli originating from and responses intended for the behavior of the service in the telecommunication network,
to detect one or more inconsistencies in the expression set, and
to recursively:
   determine a set of alternatives to resolve the inconsistencies, which set of alternatives needs the least user interaction to resolve the inconsistencies (=limit the recursion depth),
   translate the set of alternatives in a mathematical function,
   send to the user terminal possible alternatives to resolve the mathematical function,
   receive from the user terminal one of the possible alternatives, and
   update the expression set in the database using the received alternative.

By determining a set of alternatives to resolve the inconsistencies, which set of alternatives needs the least user interaction to resolve the inconsistencies, the recursion depth is limited, allowing to arrive at a consistent expression set in an efficient and quick manner.

In a further aspect, a method as defined above is provided, comprising:
creating an expression set, the expression set comprising a relationship between stimuli originating from and responses intended for the behavior of the service in the telecommunication network,
detecting one or more inconsistencies in the expression set, and
recursively:
   determining a set of alternatives to resolve the inconsistencies, which set of alternatives needs the least user interaction to resolve the inconsistencies,
   translating the set of alternatives in a mathematical function,
   sending possible alternatives to resolve the mathematical function,
   receiving one of the possible alternatives, and
   updating the expression set using the received alternative.

In other words, a rule creation engine and method are provided using a method that selects suitable possibilities to resolve key (high level) inconsistencies first, asks a question to resolve, adapt the expression set, analyse the expression again for a then highest level inconsistency, ask a question to resolve, adapt the expression set, analyse again and so on.

Using this solution, less insight in the network is required by the user and the amount of questions to be asked to solve inconsistencies in the expression set is drastically limited. Advantage of selecting a highest level issue first is that the user is confronted with high level questions, and that answering the question many lower level inconsistencies are solved in one step thus limiting the actual amount of questions to be asked.

### BRIEF DESCRIPTION OF THE DRAWINGS

The present invention embodiments will now be described in more detail with reference to the drawings, in which

FIG. 1 depicts a graphic interface for a user for inputting preferences for a rule based service in a telecommunication network;

FIG. 2 depicts a schematic representation of a telecommunication network service in which the present invention is embodied;

FIG. 3 depicts a schematic view of data flows between various elements of the expression optimizer of FIG. 2; and

FIG. 4 depicts an implementation in a telecommunication network of a connection handling service employing the present invention embodiment of an expression optimizer.

### DETAILED DESCRIPTION

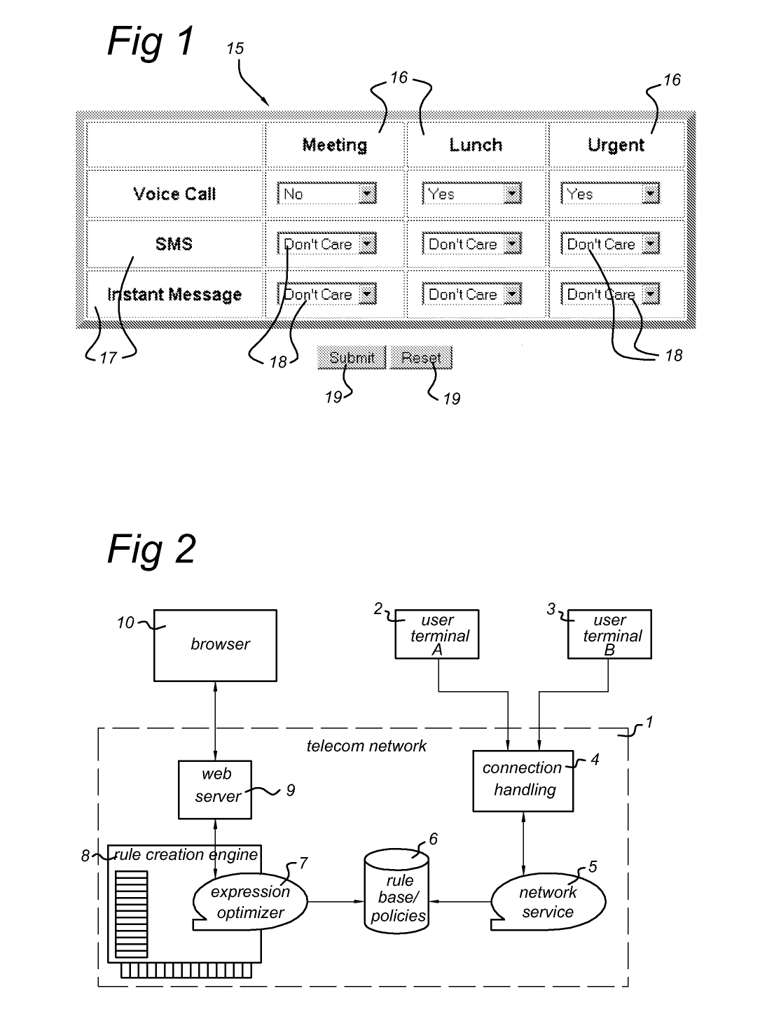

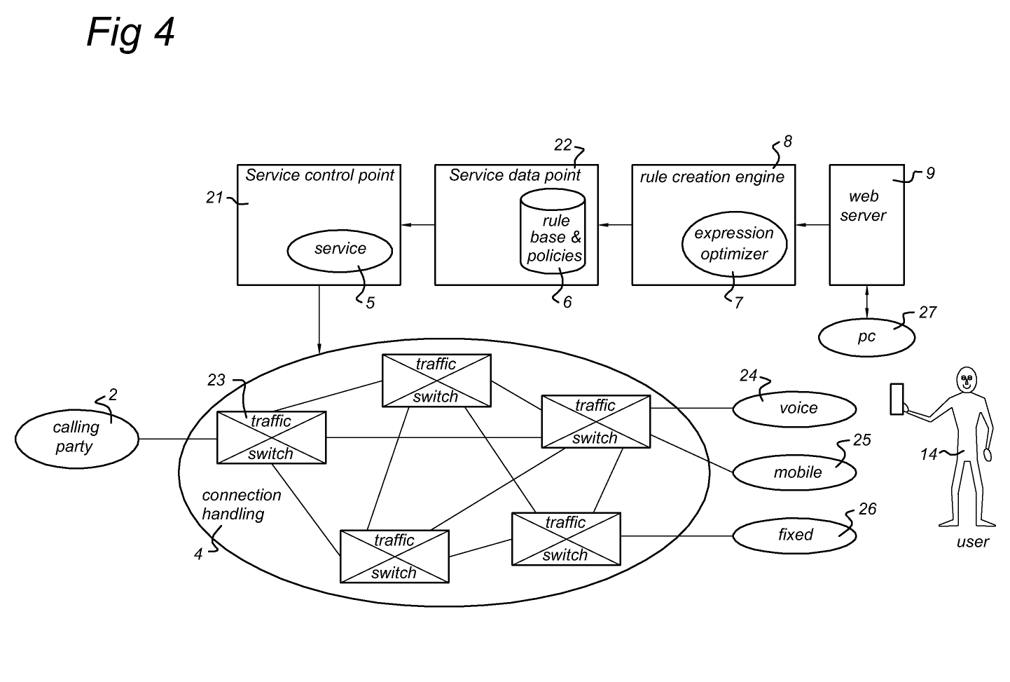

The present invention is applied in telecommunication networks, e.g. in a service provided in the telecommunication network such as connection handling. In an exemplary embodiment of such a service, a user can select whether or not different types of calls (Voice call, SMS, Instant Message) are to be received when in a meeting, at lunch or in the case of urgency. E.g. a user can provide selections in an interactive web page 15 as depicted schematically in FIG. 1. The service thus comprises transmitting a call to a user to one of possible user terminals 24-26 (see description of FIG. 4 below) dependent on one or more (external or internal) parameters.

When users are asked to provide input rules for rule engines, their answers may possibly contain conflicts or inconsistencies. These conflicts need to be detected and resolved. E.g., a user can enter his preferences (yes/no/don't care, using selection tabs 18) about receiving a voice call (row 17) in certain situations (meeting, lunch, urgent, i.e. columns 16) in the decision table as depicted in FIG. 1. From FIG. 1, it is clear that in the case of a meeting, the user does not want to receive any voice calls. However, that contradicts with the fact that when the call is urgent, or when the user is having lunch, the user does prefer voice calls. Therefore, the user must resolve the three remaining conflicts by means of more questions.

A naive solution would ask the user additional feedback for all conflicts, by presenting a list of all combinations of conditions containing these conflicts. For the example in FIG. 1 that would result in the following feedback to the user:

Would you like to receive a Voice Call under the following conditions:

Meeting+Lunch

Meeting+Urgent

Meeting+Lunch+Urgent

Unfortunately, this list will increase exponentially with the number of conditions, which leads to an unworkably long list of questions for the user to answer, and for a service to process. Besides that, it is much easier for the user to focus on just one condition, or on a minimal set of conditions, and to say e.g. “I never want to receive voice calls during a meeting”, or “I always want to receive voice calls when it is urgent”.

A schematic diagram of an actual implementation in which the present invention may be embodied is depicted in FIG. 2. A telecommunication network 1 is e.g. arranged to set up call between a first user terminal 2 and a second user terminal 3. Furthermore, a user can interact with the telecommunication network 1 via a browser 10, e.g. using a personal computer.

The telecommunication network 1 comprises a network service 5, which in this example implements a connection handling service 4 to the first and second user terminal 2, 3. For this, the network service 5 interfaces with a data store 6, in which a rule base and policies related to the connection handling service may be stored. The data relating to the rule base and policies are generated using a rule creation engine 8, which in operation is able to communicate or interface with the user via a web server 9 and browser 10 (i.e. the rule creation engine 8 comprises a web interface for communicating with a user terminal via a web server 9). It will be apparent to the skilled person that other types of user interaction with the rule creation engine 8 may be employed, e.g. based on SMS input/output or a dedicated application on a smart phone.

The present invention embodiments are implemented in the rule creation engine 8, e.g. as an expression optimizer module 7. This expression optimizer module 7 as part of the rule creation engine 8 is arranged to communicate with the database 6 and to execute the steps of the various embodiments that will be described in the following.

According to the present invention, the rule creation engine 8 is arranged to create an expression set, the expression set comprising a relationship between stimuli originating from and responses intended for the behaviour of the service in the telecommunication network. The rule creation engine 8 (e.g. as part of the functionality of the expression optimizer module 7) is furthermore arranged to detect one or more inconsistencies in the expression set.

Boolean logic minimization is applied in an embodiment (e.g. by means of the Quine/McClusky or Espresso algorithms) to resolve conflicts in expressions, i.e. a mathematical function representing the inconsistency. The output of such conflict minimization (i.e. possible alternatives to resolve the mathematical function) is presented to the user as requests for more input, e.g. in the form of presenting possible alternatives to resolve the mathematical function. When, depending on the user input, more conflicts remain, they will again be optimized by applying logic minimization. This procedure will be performed automatically and recursively as long as there are conflicts left. The stimuli (requests for more input) presented to the user as well as the responses by the user can be in other types and formats and in more or less numbers, as will be apparent to the skilled person.

This disclosure describes two automatic ways to reduce the number of conflicts a user is presented with. Both can be used independently, or combined for a better result. Both solutions start from the answers that have been provided by the user. The answers for voice calls in FIG. 1 can be depicted in the following Karnaugh diagram (Table 1), where 0 indicates ‘No’, 1 indicates ‘Yes’, X indicates ‘don't care’ and ? indicates a conflict. This map depicts the possible situations for Voice Calls as selected by the user. In the horizontal axis, the variables ‘Meeting’ and ‘Lunch’ are represented in binary form, and in the vertical the variable ‘Urgent’ is represented. The choices made by the user as depicted in FIG. 1 results in three conflict situations x, y, z in this representation.

TABLE 1
Karnaugh map for VC

| | ML | | | |
|---|---|---|---|---|
| U | 00 | 01 | 11 | 10 |
| 0 | X | 1 | x? | 0 |
| 1 | 1 | 1 | z? | y? |

A first solution consists of making a positive and negative Karnaugh map of the conflicts for Voice Calls (VC):

TABLE 21
Conflict Karnaugh map for VC = 0

| | ML | | | |
|---|---|---|---|---|
| U | 00 | 01 | 11 | 10 |
| 0 | | | 0 | 0 |
| 1 | | | 0 | 0 |

Table 21 Table 2 is a negative Karnaugh conflict map (VC=0), which results in the following optimized expression:

[symbol]

VC=M

meaning that Voice Calls are not allowed when in a meeting.

TABLE 3
Conflict Karnaugh map for VC = 1

| | ML | | | |
|---|---|---|---|---|
| U | 00 | 01 | 11 | 10 |
| 0 | | 1 | 1 | |
| 1 | 1 | 1 | 1 | 1 |

Table 3 shows a positive Karnaugh conflict map (VC=1), which results in the expression

VC=L̂U

In other words, Voice Calls are allowed when having Lunch and when it's Urgent. Note that although the Karnaugh maps shown here do not focus on Don't Cares, the expression engine implementation does take Don't Cares into account during expression optimization; Don't Cares can be either 0 or 1.

The result of Table 2 leads to the following user feedback:

Do you want to receive a Voice Call when in a meeting? (Never/Depends)

The result of Table 3 leads to the following 2 questions:

Do you want to receive a Voice Call when having lunch? (Always/Depends)
Do you want to receive a Voice Call when it is urgent? (Always/Depends)

The user then has the option to answer with Always/Never or Depends. Always will be displayed for a positive Karnaugh map (VC=1), Never for the result of a negative Karnaugh map (VC=0). The choice between a positive or negative Karnaugh map is up to the system and depends on the number of questions that need to be asked.

Thus, in a recursive manner, a first inconsistency out of the one or more inconsistencies is determined which needs the least user interaction to resolve the inconsistency. The present embodiment implementation prefers to ask the smallest number of questions per iteration, so it will prefer the first (“Do you want to receive a voice call when in a meeting?”). After all, if the user answers this question with “Never”, then the other conflicts are also resolved, as shown in Table 4:

TABLE 4
Karnaugh map for VC when Meeting = Never

| | ML | | | |
|---|---|---|---|---|
| U | 00 | 01 | 11 | 10 |
| 0 | X | 1 | 0 | 0 |
| 1 | 1 | 1 | 0 | 0 |

Should the user be unsure and choose “Depends”, then the program continues with solution 2, as explained now in more detail.

When looking back at the first example, there are three conflicts, as shown in Table 1, the conflicts are:

x?=ML [symbol] U

y?=M [symbol] LU

z?=MLU

Applying Boolean logic minimization on the conflicts results in two prime implicants, being ML (x? and z?) and MU (y? and z?). These two conditions are then presented to the user:

Meeting+Lunch(Yes/No/Don't Care)

Meeting+Urgent(Yes/No/Don't Care)

The answers to these questions will resolve the conflicts, although new conflicts could occur. Note that these conflicts can only occur for those conditions where the prime implicants overlap. The new set of conflicts (if any) will therefore be considerably smaller than the original set.

When both questions receive the same answer (both “Yes” or both “No” or both “Don't Care”), all conflicts are resolved, as there are no new conflicts, as shown in Table 5:

TABLE 5
Conflict resolution: VC = 0

| | ML | | | |
|---|---|---|---|---|
| U | 00 | 01 | 11 | 10 |
| 0 | X | 1 | 0 | 0 |
| 1 | 1 | 1 | 0 | 0 |

When there is either a “Yes” or “No” plus a “Don't Care”, there is no conflict left either, since Don't Cares don't influence the result (Table 6).

TABLE 6
Conflict resolution: VC = 1 and VC = X

| | ML | | | |
|---|---|---|---|---|
| U | 00 | 01 | 11 | 10 |
| 0 | X | 1 | X | 0 |
| 1 | 1 | 1 | 1 | 1 |

However, if the answers contain one Yes and one No, there is still a conflict left, as shown in Table 7:

TABLE 7
Conflict resolution: VC = 1 and VC = 0

| | ML | | | |
|---|---|---|---|---|
| U | 00 | 01 | 11 | 10 |
| 0 | X | 1 | 0 | 0 |
| 1 | 1 | 1 | z? | 1 |

When there are conflicts left, the mechanism starts over and again uses a Boolean logic minimization algorithm to find the prime implicants for the remaining conflicts, being MLU (z?).

The remaining conflict is then automatically shown to the user in the next iteration of the interactive session. The user is then asked whether he would like to receive a voice call under the following conditions:

Meeting+Lunch+Urgent(Yes/No/Don't Care)

When the user answers, all conflicts are resolved and the rule set or expression set is updated and stored. A similar interactive and recursive method may also be applied for the other situations in the rules and policies for this exemplary application, i.e. SMS and IM. For the skilled person it will be clear that the above embodiments may also be applied in other rule based services implemented in a telecommunication network.

The presented idea shows an intelligent way of dealing with expression conflict resolution. Instead of showing all conflicts to the user at once, the present invention embodiments recursively shows the user the conflicts after optimization, which, depending on the answer, could possibly resolve all the other conflicts at one go.

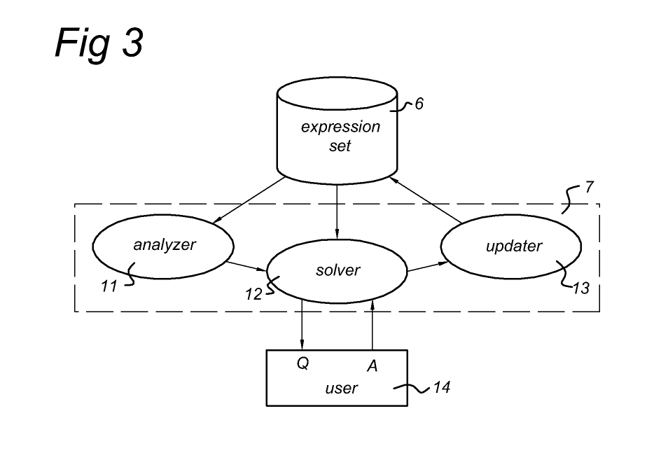

In FIG. 3 a schematic diagram is shown of the data flows and components of the expression optimizer 7 in more detail. The expression set is stored in database 6. A set of rules is retrieved from the database 6, and analyzed in an analyzer 11 using one of the embodiments described above. A solver 12 then formulates questions to be answered by the user in order to solve the detected inconsistencies, and forwards these to the user 14. The answers input by the user 14 are returned to the solver 12, and using input from the expression set in the database 6, the data is forwarded to an updater 13. The updater then uses the generated input to update the expression set in the database 6, after which a new round of analysis and questions are generated when necessary. Core of the present invention may be seen as the method executed in the analyser 11. The analyzer provides the solver 12 and the updater 13 with the mathematical function describing the detected inconsistency. The solver 12 generates the question based on the input provided by the analyzer 11 and the descriptions of stimuli and responses stored with the expression set in database 6. The user 14 provides one of the answers allowed by the solver 12. The solver 12 then forwards the mathematical answer that is then used by the updater 13 to adapt the set of expressions in database 6.

The functions analyser 11, solver 12 and updater 13 may be implemented as software modules on data processing units, e.g. network units in a telecommunications network 1. Alternatively, a dedicated hardware unit may be provided, such as the rule creation engine 8. In all cases, the data processing unit or other hardware unit is provided with processing units, local memory (e.g. for storing instructions) and the associated interfacing circuitry to allow data communication with other units.

FIG. 4 depicts a schematic diagram of an implementation of a connection handling service 5 in a telecommunication network 1. Similar functional modules as in the drawing of FIG. 2 have the same reference numerals. The connection handling 4 is implemented in the telecommunication network 1 using a plurality of traffic switches 23 guiding the connection from a calling party (or first user terminal 2) to one of several communication sinks of the user 14 (cf. the second terminal 3 in FIG. 2). The destination of the call from the calling party 2 to the user 14 can be a voice message terminal 24, a mobile terminal 25 or a fixed terminal 26 in this embodiment. The connection by the connection handling module 4 is in this embodiment controlled by a service control point 21 (i.e. a network unit in the telecommunication network 1), which implements the service 5. The service 5 interacts with the database 6 in which rules and policies are stored, and which is part of another network unit, i.e. a service data point 22. The data for the rules and policies in database 6 is generated by the rule creation engine 8, which executes the expression optimizer function or module 7. The rule creation engine 8 interfaces again with a web server 9 to allow entry of user input using a personal computer 27. As an alternative, the rule creation engine 8 is also implemented in a network node of the telecommunication network, such as the SDP 22 or SCP 21. In other types of telecommunication networks, the rule creation engine 8 may also be implemented in relevant network nodes, such as an CSCF (call session control function) in an SIP (session Initiation protocol) network.

It will be apparent to the skilled person that modifications or amendments may be incorporated in practical implementations of the above described embodiments of methods and rule creation engine 8. These modifications and amendments are included in the scope of this application, as defined by the claims as appended.

1-15. (canceled)

16. A rule creation engine for a service provided in a telecommunication network, wherein the rule creation engine is communicatively coupled with a user terminal and a database and is configured to:
create an expression set in said database, wherein the expression set defines different responses in the behavior of said service to different stimuli in the telecommunication network, and
resolve one or more inconsistencies in the expression set by, for each of one or more recursive iterations:
detecting one or more inconsistencies in the expression set associated with one or more stimuli in the telecommunication network,
determining a set of alternative responses in the behavior of said service that could resolve at least one of the one or more detected inconsistencies using the least interaction with the user terminal during the iteration,
translating the set of alternatives into a mathematical function,
sending to the user terminal possible alternatives to resolve the mathematical function,
receiving from the user terminal one of the possible alternatives, and
updating the expression set in the database using the received alternative.

17. The rule creation engine according to claim 16, wherein the mathematical function comprises Boolean logic.

18. The rule creation engine according to claim 17, further comprising determining possible alternatives to resolve the mathematical function using Boolean logic minimization.

19. The rule creation engine according to claim 18, wherein the Boolean logic minimization comprises application of a Quine/McClusky algorithm.

20. The rule creation engine according to claim 18, wherein the Boolean logic minimization comprises application of an Espresso algorithm.

21. The rule creation engine according to claim 16, further comprising a web interface for communicating with the user terminal via a web server.

22. The rule creation engine according to claim 16, wherein the service in the telecommunication network is connection handling and comprises transmitting a call destined for a user to one of a plurality of possible user terminals for that user, depending on one or more parameters.

23. The rule creation engine according to claim 16, wherein the rule creation engine is implemented in a network node of the telecommunication network.

24. The rule creation engine according to claim 23, wherein the network node comprises either a service data point, a service control point, or a web server.

25. A method for creating rules for a service provided in a telecommunication network to a user terminal, comprising:
creating an expression set in a database, wherein the expression set defines different responses in the behavior of said service to different stimuli in the telecommunication network, and
resolving one or more inconsistencies in the expression set by, for each of one or more recursive iterations:
detecting one or more inconsistencies in the expression set associated with one or more stimuli in the telecommunication network,
determining a set of alternative responses in the behavior of said service that could resolve at least one of the one or more detected inconsistencies using the least interaction with the user terminal during the iteration,
translating the set of alternatives into a mathematical function,
sending to the user terminal possible alternatives to resolve the mathematical function,
receiving from the user terminal one of the possible alternatives, and
updating the expression set in the database using the received alternative.

26. The method according to claim 25, wherein the mathematical function comprises Boolean logic.

27. The method according to claim 26, further comprising determining possible alternatives to resolve the mathematical function using Boolean logic minimization.

28. The method according to claim 27, wherein the Boolean logic minimization comprises application of a Quine/McClusky algorithm.

29. The method according to claim 27, wherein the Boolean logic minimization comprises application of an Espresso algorithm.

30. The method according to claim 25, wherein the service in the telecommunication network is connection handling and comprises transmitting a call destined for a user to one of a plurality of possible user terminals for that user, depending on one or more parameters.

31. The method according to claim 25, wherein the method is implemented in a rule creation engine.

32. The method according to claim 25, wherein the rule creation engine is implemented in a network node of the telecommunication network.

33. The method according to claim 32, wherein the network node comprises either a service data point, a service control point, or a web server.
